(19) United States
(12) Patent Application Publication
(10) Pub. No.: US 2024/0408605 A1
(43) Pub. Date: Dec. 12, 2024

(54) MULTIFUNCTION RACK FOR STORAGE OF CYTOHISTOLOGICAL SLIDES, HISTOLOGICAL BIOCASSETTES OR VIALS CONTAINING HISTOLOGICAL SAMPLES

(71) Applicant: LOGIBIOTECH SRL, MILANO (IT)

(72) Inventor: Lorenzo CAMPANINI, FIDENZA (IT)

(21) Appl. No.: 18/699,880

(22) PCT Filed: Oct. 26, 2022
(86) PCT No.: PCT/IT2022/050284

§ 371 Date: Apr. 9, 2024

(30) Foreign Application Priority Data
Oct. 29, 2021 (IT) 102021000027746

(51) Int. Cl. B01L 9/00; B01L 3/00

(52) U.S. Cl. CPC B01L 9/523; B01L 3/50855; B01L 2200/025; B01L 2200/028; B01L 2200/04; B01L 2300/021; B01L 2300/0609; B01L 2300/0829; B01L 2300/0858

(57) ABSTRACT

The invention concerns a multifunction rack for storage of cytohistological slides, histological biocassettes or vials containing histological samples, characterized in that it comprises: at least one pair of modular units (1) comprising a plurality of cells (6), arranged according to an array of rows and columns, and two pairs of wedge-shaped teeth (2′, 2″) projecting from outer walls of opposite sides, with respective centre distances of each pair having different width from each other; a box-like structure (3) containing said modular units (1), provided with housing seats (4′, 4″) and slots (5′, 5″) for locking said teeth (2′, 2″) of said modular units (1), arranged on inner walls of opposite sides, with respective centre distances having different width from each other, where a rotation of 180° of said modular units (1) around a vertical axis determines matching or otherwise of the centre distances of said teeth (2′, 2″) with the centre distances of the same width of said respective housing seats (4′, 4″) or of said respective locking slots (5′, 5″) and consequently the reversible insertion or irreversible fixing of said modular units (1) inside said box-like structure (3).

### TECHNICAL FIELD OF APPLICATION

The invention applies to the technical field of equipment for the storage and orderly conservation of bioptic samples.

More specifically, the invention concerns a multifunction rack for the storage of cytohistological slides, histological biocassettes or vials (small bottles) containing histological samples, below defined simply as slides, biocassettes and vials.

### STATE OF THE ART

As known, the procedures for the storage and orderly conservation of bioptic samples in hospital anatomical pathology departments entail storage in cabinets provided internally with modular racks, designed to contain them in an orderly manner inside individual housings, spaced from one another so as to accommodate the thickness of the slides or biocassettes in which the samples are arranged.

One of said racks is known from the patent application 102019000018425 of the same applicant.

As is also known, said racks generally have the following problems:
they are provided with a predefined invariable number of housings;
they are provided with housings having one single spacing that prevents simultaneous storage and conservation of slides and biocassettes of different dimensions;
   they are without housings for the storage and conservation of vials.

### Presentation of the Invention

The object of the invention is to overcome the above drawbacks of the current racks for the storage of bioptic samples.

The object of the invention is achieved by a multifunction rack for the storage of cytohistological slides, histological biocassettes or vials containing histological samples, according to the main independent claim 1.

Further characteristics of the invention are described in the dependent claims.

A multifunction rack for the storage of cytohistological slides, histological biocassettes or vials containing histological samples, according to the invention, offers the following important advantages:
by means of modular units, it allows the type of samples and number of slides or biocassettes stored and conserved in the racks to be varied;
by means of said units, it allows slides and biocassettes of different dimensions to be stored and conserved simultaneously in the racks;
by means of said units, it allows vials to be stored and conserved in the racks, together with or separately from slides or biocassettes.

### BRIEF DESCRIPTION OF THE DRAWINGS

Further characteristics and advantages of the invention will become more evident from the more detailed description provided below, with the help of the drawings that show a preferred embodiment thereof, illustrated by way of non-limiting example, in which:

FIG. 1-2 show, in axonometric view, the general conformation and a construction detail of a modular unit forming part of a multifunction rack for the storage of cytohistological slides, histological biocassettes and vials containing histological samples, according to the invention;

FIG. 3-4-5 show, in axonometric view, possible shape variations of said modular unit of said rack;

FIG. 6-7 show, in axonometric view from opposite sides, the general conformation of a box-like structure containing said modular unit of said rack;

FIG. 8-9 show, in axonometric view from opposite sides of the rack, a modular unit of said rack during the phase of reversible insertion in the relative box-like containment structure;

FIG. 10-11 show, in axonometric view from opposite sides of the rack, a modular unit of said rack once it has been reversibly inserted in the relative box-like containment structure;

FIG. 12-13 show, in axonometric view from opposite sides of the rack, a modular unit of said rack during insertion into the relative box-like containment structure to obtain irreversible locking;

FIG. 14-15 show, in axonometric view from the opposite sides of the rack, a modular unit of said rack once it has been irreversibly locked in the relative box-like containment structure.

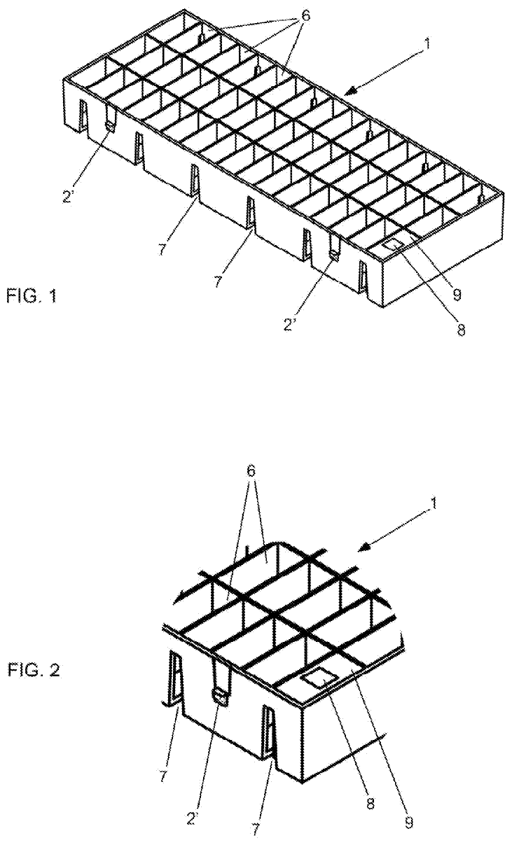

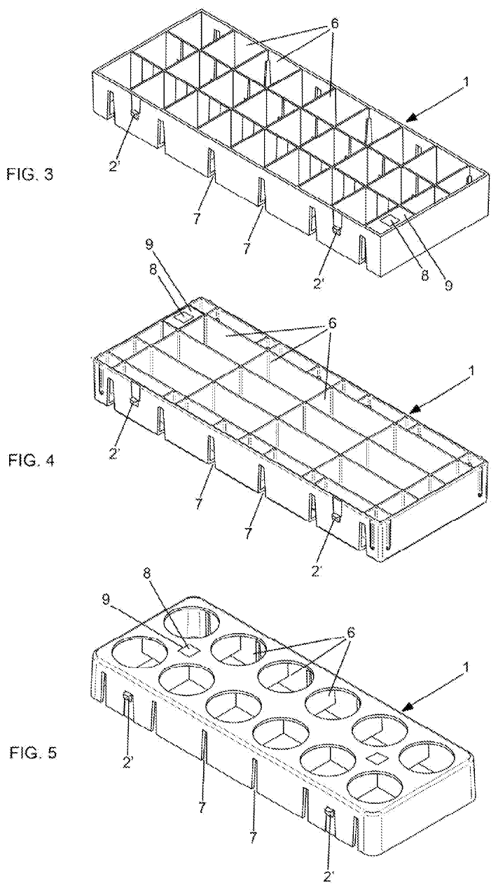

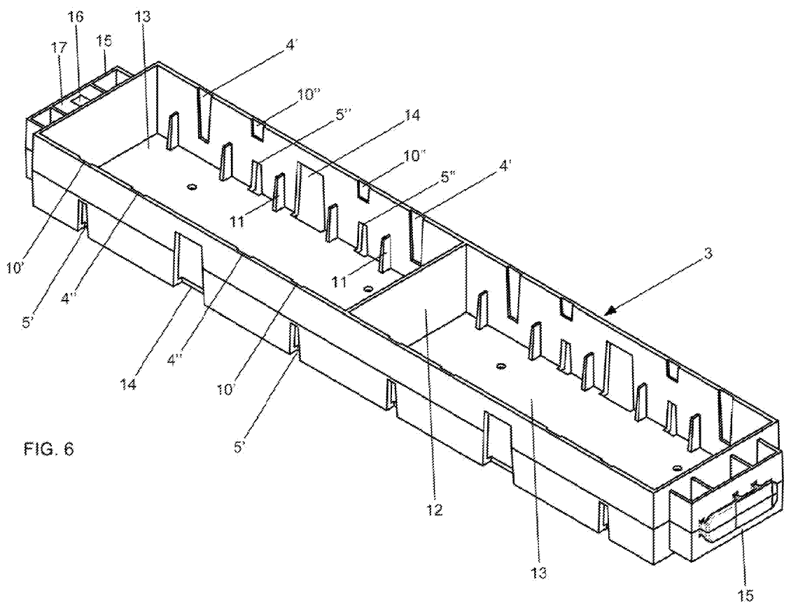

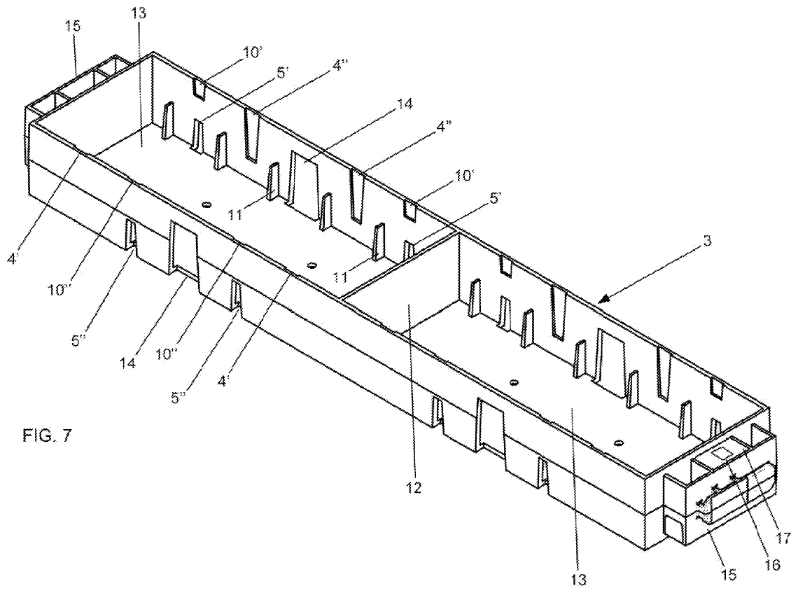

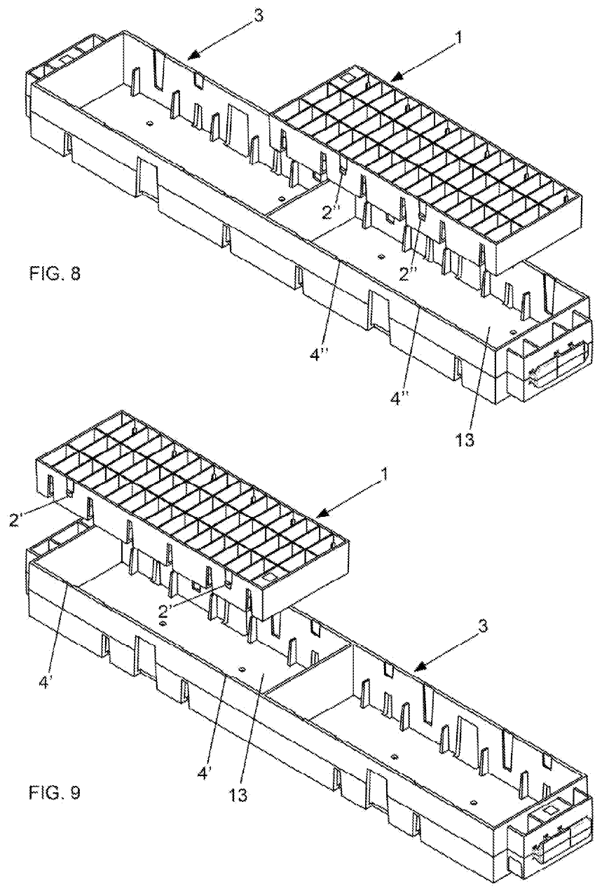

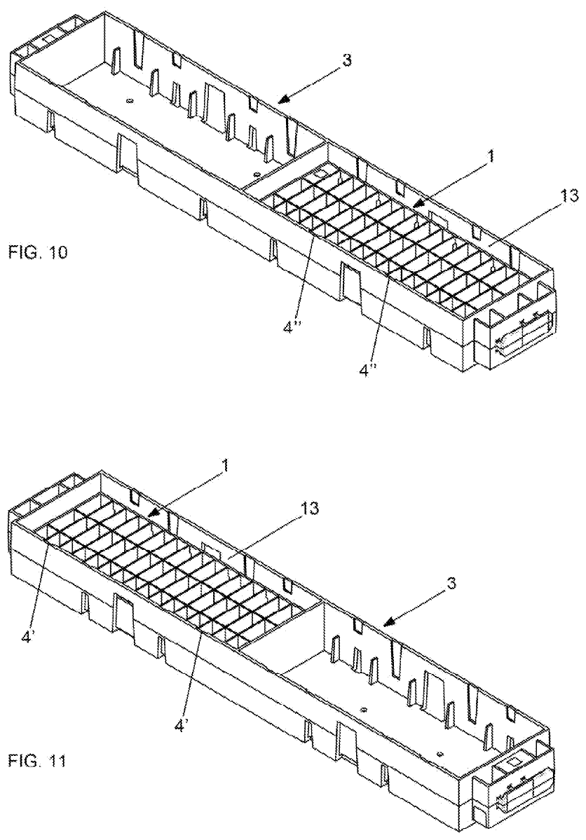

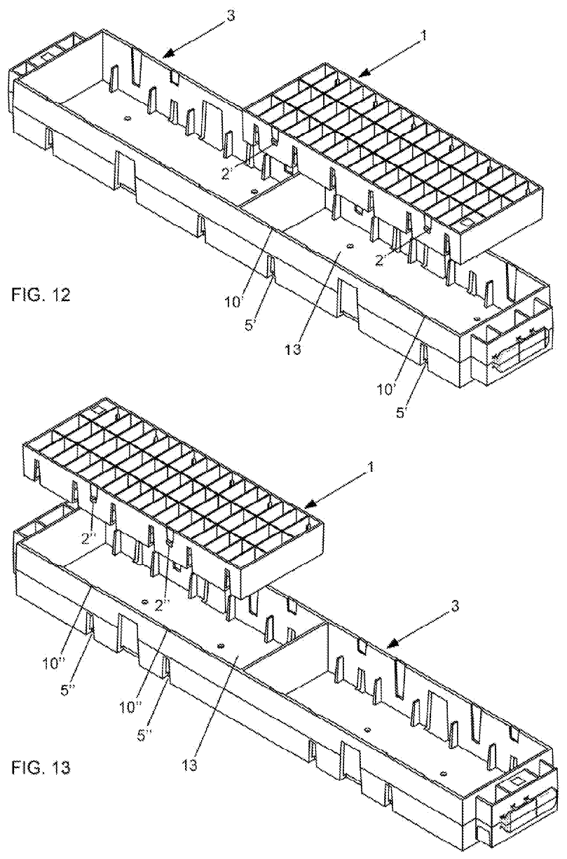

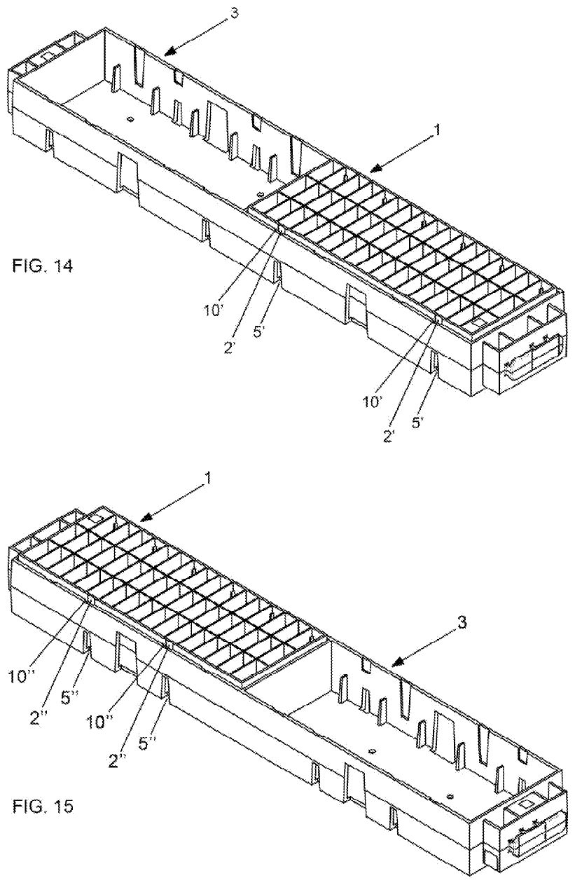

### DETAILED DISCLOSURE OF A PREFERRED EMBODIMENT OF THE INVENTION

With reference to the details of the figures, a multifunction rack for the storage of cytohistological slides, histological biocassettes or vials containing histological samples, according to the invention, comprises substantially:
at least one pair of modular units 1, provided with two pairs of wedge-shaped teeth 2′, 2″ projecting from outer walls of opposite sides, with respective centre distances of each pair having different width from each other;
a box-like structure 3, containing said modular units 1, provided with housing seats 4′, 4″ and slots 5′, 5″ for locking said teeth 2′, 2″ of said modular units 1, arranged on inner walls of the opposite sides, with respective centre distances having different width from each other.

Said modular units 1 further comprise:
a plurality of cells 6, advantageously arranged according to an array of rows and columns, with shapes and dimensions appropriately chosen to house respectively cytohistological slides, histological biocassettes or vials containing histological samples.

Said modular units 1 further comprise:
linear guides 7 having the shape of a groove with vertical course, arranged on the outer walls of opposite sides;
an identification plate 8, of barcode or qrcode type, arranged on a support 9 that can be housed in one of the cells 6 or obtained from one of them, located in a predefined position, that can be easily and securely reached by automated or manual reading apparatus.

Said box-like structure 3 comprises:
seats 10′, 10″ for aligning the teeth 2′, 2″ of said modular units 1 with the respective locking slots 5′, 5″, arranged on an upper margin of inner walls of the opposite sides, on the same vertical axis as said locking slots 5′, 5″;
tabs 11 for engaging the linear guides 7 of said modular units 1, projecting from the opposite inner walls and from a base bottom;
at least one transverse partition 12 delimiting containment compartments 13 for said modular units 1.

Said box-like structure 3 further comprises:
lightening slots 14, arranged on opposite sides;
reversible fixing structures 15 for fixing to storage cabinet doors, arranged on opposite heads;
an identification plate 16, of barcode or qrcode type, prearranged on a support 17 that can be housed in one of the fixing structures 15 or obtained from one of them, located in a predefined position, that can be easily and securely reached by automated reading apparatus.

The operation of the invention is described below.

A 180° rotation of the modular units 1 around a vertical axis determines matching of the centre distances of the teeth 2′, 2″, prearranged on the outer walls of the opposite sides, with the centre distances of the same width of the respective housing seats 4′, 4″ or of the respective locking slots 5′, 5″, prearranged on the inner walls of the opposite sides of the box-like structure 3.

Matching of the centre distances of the teeth 2′, 2″ with the centre distances of the respective housing seats 4′, 4″ allows the modular units 1 to be reversibly inserted inside the box-like structure 3.

The reversible insertion of the modular units 1 inside the box-like structure 3 allows said modular units 1 to be conserved directly inside said box-like structure 3 until the moment of use, advantageously reducing overall dimensions and storage space.

Vice versa, matching of the centre distances of the teeth 2′, 2″ with the centre distances of the respective locking slots 5′, 5″ allows the modular units 1 to be inserted and fixed irreversibly inside the box-like structure 3.

The teeth 2′, 2″ of the modular units 1 cooperate in advance with the seats 10′, 10″ of the box-like structure 3, arranged on the upper margin of the inner walls of the opposite sides, in order to be perfectly aligned on the same vertical axis of the respective locking slots 5′, 5″ and consequently be fitted inside said locking slots 5′, 5″ following a minimum pressure exerted manually on said modular units 1.

The entry of the teeth 2′, 2″ into the respective locking slots 5′, 5″ is facilitated by the oblique anterior portion of the wedge, while the exit of said teeth 5′, 5″ from said respective locking slots 5′, 5″ is prevented by the flat rear portion of the wedge.

The linear guides 7 with vertical course of the modular units 1, arranged on the lateral walls of the opposite sides, cooperate with the tabs 11 of the box-like structure 3, interposed between the opposite inner walls and the base bottom, in order to:
determine a perfectly vertical descent of the modular units 1 inside the box-like structure 3 and consequently favour their reversible insertion or their irreversible fixing inside the same;
stabilize the resting of the modular units 1 on the bottom of the base of the box-like structure 3 once they have been reversibly inserted or irreversibly fixed inside the same.

The insertion and irreversible fixing of the modular units 1 inside the box-like structure 3 allows the configuration of the racks resulting from the assembly of said modular units 1 and said box-like structure 3 to be varied according to specific needs in terms of storage and conservation of slides, biocassettes or vials.

The modular units 1 comprise a plurality of cells 6 with shapes and dimensions appropriately chosen to house said slides, said biocassettes or said vials.

Several modular units 1 provided with cells 6 having the same shape and dimension can be associated with the same box-like structure 3 in order to increase the overall number of slides, biocassettes or vials that can be housed in the rack resulting from the assembly thereof.

Analogously, several modular units 1 provided with cells 6 having different shape and dimension can be associated with the same box-like structure 3 in order to allow the joint housing of slides, biocassettes or vials in the rack resulting from the assembly thereof.

In particular, within the individual modular units 1 it is possible to house:
slides of standard type (25 mm×75 mm), mega type (39 mm×75 mm) or super-mega type (52 mm×75 mm), in a variable number according to their respective dimensions;
fifty biocassettes of standard type;
twenty-four biocassettes of mega type;
twenty-four biocassettes of super-mega type;
12 vials.

The slides, biocassettes or vials in the respective cells 6 of the modular units 1 can be housed in either manual or automated mode.

The racks resulting from assembly of the modular units 1 and of the box-like structure 3, once the cells 6 of the modular units 1 have been filled, are transported to containment cabinets and secured inside them by means of the fixing structures 15, arranged on the opposite heads.

Said fixing structures 15 are designed to be inserted and interlocked reversibly in corresponding housing seats prearranged on the opposite uprights of the doors of said cabinets, so as to allow fixing of the racks to the cabinets or removal therefrom without the aid of specific tools.

In the case of removal of the racks from the cabinets, they can be identified by a plate 16, of the barcode or qrcode type, prearranged on a support 17 housed in one of the fixing structures 15 or obtained from one of them, located in a predefined position, easily and securely reached by automated or manual reading apparatus.

In the case of subsequent insertions or withdrawals of slides, biocassettes or vials from the cells 6 of the modular units 1, they can be identified by a plate 8, of the barcode or qrcode type, prearranged on a support 9 housed in one of the cells 6 or obtained from one of them, also located in a predefined position, easily and securely reached by automated or manual reading apparatus.

1. A multifunction rack for storage of cytohistological slides, histological biocassettes or vials containing histological samples, characterized in that it comprises:
at least one pair of modular units (1) comprising a plurality of cells (6), arranged according to an array of rows and columns, and two pairs of wedge-shaped teeth (2′, 2″) projecting from outer walls of opposite sides, with respective centre distances of each pair having different width from each other;
a box-like structure (3) containing said modular units (1), provided with housing seats (4′, 4″) and slots (5′, 5″) for locking said teeth (2′, 2″) of said modular units (1), arranged on inner walls of opposite sides, with respective centre distances having different width from each other,
where a rotation of 180° of said modular units (1) around a vertical axis determines matching or otherwise of the centre distances of said teeth (2′, 2″) with the centre distances of the same width of said respective housing seats (4′, 4″) or of said respective locking slots (5′, 5″) and consequently the reversible insertion or irreversible fixing of said modular units (1) inside said box-like structure (3).

2. The rack according to claim 1, characterized in that the modular units (1) comprise linear guides (7) having the shape of a groove with vertical course, arranged on the outer walls of the opposite sides.

3. The rack according to claim 1, characterized in that the modular units (1) comprise an identification plate (8), of the barcode or qrcode type, prearranged on a support (9) that can be housed in one of the cells (6) or obtained from one of them.

4. The rack according to claim 1, characterized in that the box-like structure (3) comprises seats (10′, 10″), arranged on an upper margin of the inner walls of the opposite sides, designed to cooperate with the teeth (2′, 2″) of the modular units (1) to determine alignment of the respective locking slots (5′, 5″) on the same vertical axis.

5. The rack according to claim 2, characterized in that the box-like structure (3) comprises tabs (11) projecting from the opposite inner walls and from a base bottom, designed to cooperate with the linear guides (7) of the modular units (1) to determine the vertical descent of said modular units (1) inside said box-like structure (3) and to stabilize the resting of said modular units (1) on said bottom of the base of said box-like structure (3).

6. The rack according to claim 1, characterized in that the box-like structure (3) comprises at least one transverse partition (12) delimiting containment compartments (13) of the modular units (1).

7. The rack according to claim 1, characterized in that the box-like structure (3) comprises lightening slots (14), arranged on opposite sides.

8. The rack according to claim 1, characterized in that the box-like structure (3) comprises reversible fixing structures (15) for fixing to storage cabinet doors, arranged on opposite heads.

9. The rack according to claim 8, characterized in that the box-like structure (3) comprises an identification plate (16), of barcode or qrcode type, prearranged on a support (17) that can be housed in one of the fixing structures (15) or obtained from one of them.
